(19) United States
(12) Patent Application Publication
(10) Pub. No.: US 2026/0154009 A1
(43) Pub. Date: Jun. 4, 2026

(54) PER ROW HAMMER TRACKING ARRAY STRUCTURE

(71) Applicant: Micron Technology, Inc., Boise, ID (US)

(72) Inventors: Kevin John Platt, McKinney, TX (US); Jason M. Brown, Allen, TX (US)

(21) Appl. No.: 19/399,376

(22) Filed: Nov. 24, 2025

Related U.S. Application Data
(60) Provisional application No. 63/727,569, filed on Dec. 3, 2024.

(51) Int. Cl. G06F 3/06

(52) U.S. Cl. CPC G06F 3/0659; G06F 3/0604; G06F 3/0673

(57) ABSTRACT

Methods, systems, and devices for per row hammer tracking array structure are described. A memory system may determine a quantity of columns of a memory array that have respective writeback times that satisfy a threshold duration for storing a row access count. The memory device may activate a first row of the memory array, the first row corresponding to a first row address. The memory device may activate a redundant column to perform a first access operation on a set of data bits associated with a first column address corresponding to a first column of the memory array. Then, the memory device may activate the first column of the memory array to perform a second access operation on a set of counter bits of a counter circuit that includes a count value corresponding to a quantity of accesses at the first row.

### CROSS REFERENCE

The present Application for Patent claims priority to U.S. Patent Application No. 63/727,569 by Platt et al., entitled “PER ROW HAMMER TRACKING ARRAY STRUCTURE,” filed December 03, 2024, which is assigned to the assignee hereof, and which is expressly incorporated by reference in its entirety herein.

### TECHNICAL FIELD

The following relates to one or more systems for memory, including per row hammer tracking array structure.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports per row hammer tracking array structure in accordance with examples as disclosed herein.

FIG. 2 shows an example of a column diagram that supports per row hammer tracking array structure in accordance with examples as disclosed herein.

FIG. 3 shows an example of a memory array diagram that supports per row hammer tracking array structure in accordance with examples as disclosed herein.

FIG. 4 shows a block diagram of a memory system that supports per row hammer tracking array structure in accordance with examples as disclosed herein.

FIGS. 5 and 6 show flowcharts illustrating a method or methods that support per row hammer tracking array structure in accordance with examples as disclosed herein.

### DETAILED DESCRIPTION

Some memory systems may be vulnerable to row hammer attacks, which may result in data corruption at one or more rows of memory. To mitigate such issues, a memory system may use a per row activation count (PRAC) counter to track a quantity of activations at each row of a memory die. However, bits for a PRAC counter may have a writeback time that exceeds a threshold duration for storing a row access count, which may cause difficulties with recording the quantity of activations at each row of the memory die.

A quantity of columns of a memory array of a memory device that have respective writeback times that satisfy a threshold duration for storing a row access count may be determined. For example, a testing device may perform a test operation on a memory device to determine a set of performance levels associated with each column of a first set of columns corresponding to a first set of memory cells of the memory device. Then, the testing device may identify one or more columns of the first set of columns based on the one or more columns being associated with respective performance levels that each satisfy a threshold performance level. The testing device may perform a programming operation of a first fuse location associated with a first redundant column such that a first column address associated with a first column of the one or more columns maps to the first redundant column and such that a subset of bits of a counter circuit maps to the first column address.

The memory device may receive an access command associated with an access operation that indicates a first row address and a first column address of the memory array, and may activate a first row associated with the first row address. In response to the access command, the memory device may activate, based on a value programmed at a first fuse location of a fuse array indicating a first column associated with the first column address, a first set of switches coupled with the first fuse location to map the first column address to a redundant column for the access operation. Similarly, the memory device may activate a second set of switches to map a subset of bits of a counter circuit to the first column address. Activation of the second set of switches may read respective values of memory cells associated with the first column address to the subset of bits of the counter circuit. Then, the memory device may increment a counter value in the counter circuit in response to activation of the first row, and may write the subset of bits of the counter value to the memory cells associated with the first column address and the first row in response to an indication to deactivate the first row.

In addition to applicability in memory systems as described herein, techniques for a per row hammer tracking array structure may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by efficiently determining one or more high performance columns to use for a PRAC counter, which may increase performance of detecting row hammer attacks at a memory device, among other benefits.

In addition to applicability in memory systems as described herein, techniques for a per row hammer tracking array structure may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by tracking row hammer attacks at each row of a memory array, which may extend the life of electronic devices, thereby reducing electronic waste, among other benefits.

Features of the disclosure are illustrated and described in the context of systems and architectures. Features of the disclosure are further illustrated and described in the context of a column diagram, a memory array diagram, and flowcharts.

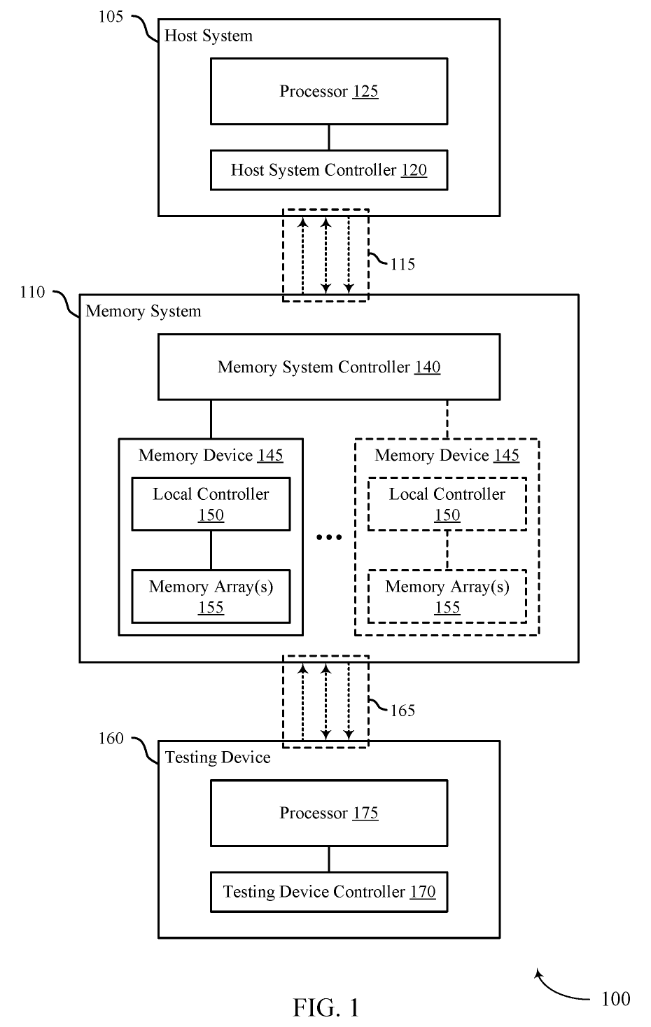

FIG. 1 shows an example of a system 100 that supports per row hammer tracking array structure in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

As described herein, a PRAC counter (in some cases referred to as a per row hammer tracking (PRHT) counter) may refer to a counter that tracks a quantity of accesses at a particular row (e.g., word line) of the memory system 110. The memory system 110 (or in some cases, another device associated with the memory system 110) may include a PRAC counter for one or more rows or one or more memory arrays within the memory system 110. Hammer tracking may refer to a process of detecting row hammer attacks. For example, the memory system 110 may implement a PRAC counter (or a PRHT counter) to detect if a row has been a target for a row hammer attack (e.g., if a bad actor takes advantage of a side effect of a DRAM device in which memory cells begin to leak charges).

As described herein, a column select (CS) column may refer to a column within a memory array that may addressed via CS bits of an access command (e.g., a “regular” column of the memory array). In some cases, a global redundant column select (GRCS) column may refer to a column that includes redundant memory cells. The memory system 110 may use one or more GRCS columns to replace (e.g., repair out) one or more CS columns of a memory array (e.g., for replacing poorly performing CS columns or for utilizing CS columns that perform well for other purposes). In some examples, a GRCS column may be referred to as a redundant column or as a redundant CS column.

In some implementations, a fuse array may refer to a set of multiple fuses within the memory system 110. The fuse array may include a set of fuse locations, which may refer to a subset of one or more fuses within the fuse array. The memory system 110 (or another device) may program (e.g., blow) one or more fuses of the fuse array (e.g., a fuse location) to modify couplings between one or more components of the memory system 110. For example, the memory system 110 may program one or more fuses to map a GRCS column to a set of data pins (e.g., output or input pins) associated with a CS column of the memory system 110. Additionally, or alternatively, the memory system 110 may program one or more fuses to map the CS column to a set of bits of a PRAC counter associated with a row of the memory system 110.

In some cases, a writeback time (e.g., a tWR) may refer to a duration to complete a writeback procedure at a set of memory cells (e.g., by activating a particular row and a particular column of a memory array). In some examples, a testing device 160 may perform tests on the memory system 110 (e.g., via a testing channel 165) to determine a CS column that satisfies a threshold writeback time (e.g., for all rows that intersect with the CS column). The testing device 160 may determine one or more performance levels of CS columns in this way. A performance level may refer to a writeback time or another performance measure for a storage element within the memory system 110.

As described herein, a set of columns of a memory array of a memory device 145 that have writeback times satisfying a threshold duration for storing a row access count (e.g., a set of “high performing” columns) may be determined. For example, a testing device 160 may include a testing device controller 170 and a processor 175, and thus the testing device 160 may be operable to perform tests on one or more memory devices 145 of the memory system 110 (e.g., while installed in the memory system 110, prior to being installed in the memory system 110). In some implementations, the testing device 160 (e.g., using the testing device controller 170) may perform a test operation on a memory device 145 of the memory system 110 to determine a set of performance levels associated with each column of a first set of columns corresponding to a first set of memory cells of the memory device 145 (e.g., at a memory array 155). Then, the testing device 160 may identify one or more columns of the first set of columns based on the one or more columns being associated with respective performance levels that each satisfy a threshold performance level. The testing device 160 may perform a programming operation of a first fuse location associated with a first redundant column. The programming operation may cause a first column address associated with a first column of the one or more columns to map to the first redundant column. Further, the programming operation may result in a mapping between a subset of bits of a counter circuit and the first column address.

In some implementations, the memory device 145 may receive (e.g., from a host system 105) an access command associated with an access operation that indicates a first row address and a first column address of a memory array 155, and may activate a first row associated with the first row address. In response to the access command, the memory device 145 may activate a first set of switches coupled with a first fuse location of a fuse array to map the first column address to a redundant column (e.g., a GRCS column) for the access operation. For example, the memory device 145 may activate the first set of switches based on a value programmed at the first fuse location indicating a first column associated with the first column address. Similarly, the memory device 145 may activate a second set of switches to map a subset of bits of a counter circuit to the first column address. Activation of the second set of switches may read respective values of memory cells associated with the first column address to the subset of bits of the counter circuit. Then, the memory device 145 may increment a counter value in the counter circuit in response to activation of the first row, and may write the subset of bits of the counter value to the memory cells associated with the first column address and the first row in response to an indication to deactivate the first row.

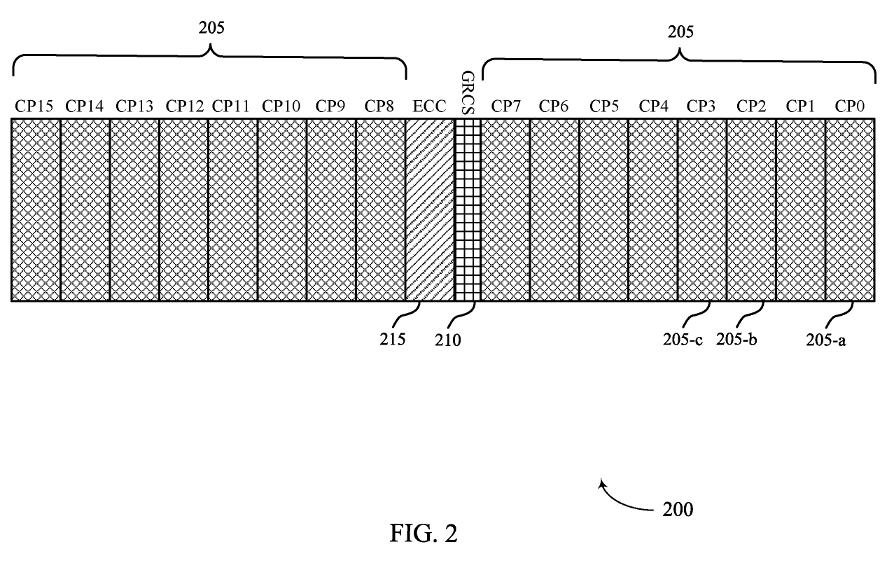

FIG. 2 shows an example of a column diagram 200 that supports per row hammer tracking array structure in accordance with examples as disclosed herein. In some cases, aspects of the column diagram 200 may implement or be implemented by aspects of the system 100. For example, the column diagram 200 may include a set of column planes 205 (e.g., a column plane 205-a, a column plane 205-b, and a column plane 205-c). Each column plane (“CP”) may include a quantity of columns, where each column is associated with a quantity of (e.g., eight) storage elements (e.g., per row) of a memory array 155 within a memory device 145. Further, the column diagram 200 may include a GRCS plane 210 and an error correction code (ECC) plane 215, which may be included in the memory array 155. For example, the GRCS plane 210 may include a set of GRCS columns (e.g., eight GRCS columns, represented by GRCS <7:0>). The ECC plane 215 may include a set of bits for error correcting data bits within the set of column planes 205, within the GRCS plane 210, or both.

In some implementations, the memory device 145 may use a quantity of (e.g., 24) bits for a PRAC counter of the memory device 145. As described herein, a PRAC counter may refer to a PRHT counter (e.g., these terms may be used interchangeably herein). Each column plane 205 may include a respective set of CS columns, where each CS column of a set of CS columns may include eight bits (e.g., per row). As described herein, a CS column may refer to a column that is addressed via CS bits of an access command (e.g., received at the memory device 145). Since each CS column may include eight bits, the memory device 145 may select three CS columns (e.g., three normal CSELs) from each of three column planes 205 (e.g., different or unique column planes) for the PRAC counter. In a first selection operation, the memory device 145 may activate a first set of switches to map the three CS columns to respective subsets of bits of the PRAC counter (e.g., mapping each CS column of the three CS columns to a respective set of eight bits of the PRAC counter). In a second selection operation, the memory device 145 may activate a second set of switches to map each GRCS column of a set of three GRCS columns to each of the three CS columns. Thus, the memory device 145 may activate each of the three CS columns (e.g., and a corresponding row) to perform access operations on the PRAC counter (e.g., reading, writing, modifying, incrementing, and so on). Further, the memory device 145 may activate each of the three GRCS columns to perform access operations on data associated with the three CS columns.

In some implementations, the memory device 145 may map each CS column of the three CS columns to a unique GRCS column within the GRCS plane 210. For example, the memory device 145 may replace a CS column of the column plane 205-b (e.g., CP2 CSEL <33>) with a first GRCS column of the GRCS plane 210 (e.g., index 0 of the GRCS plane 210, or GRCS <0>). Further, the memory device 145 may replace a CS column of the column plane 205-c (e.g., CP3 CSEL <22>) with a second GRCS column of the GRCS plane 210 (e.g., index 1 of the GRCS plane 210, or GRCS <1>). Additionally, or alternatively, the memory device 145 may replace a CS column of the ECC plane 215 (e.g., ECC Plane CSEL <14>) with a third GRCS column of the GRCS plane 210 (e.g., index 2 of the GRCS plane 210, or GRCS <2>).

The memory device 145 may thus map the CS column of the column plane 205-b, the CS column of the column plane 205-c, and the CS column of the ECC plane 215 to respective portions of the PRAC counter. In some implementations, the memory device 145 may activate (e.g., fire) a set of CS columns to access the PRAC counter. For example, the memory device 145 may activate the CS column of the column plane 205-b, the CS column of the column plane 205-c, and the CS column of the ECC plane 215 to perform operations on the PRAC counter (e.g., increment, decrement, read, write, and so on).

In some implementations, the PRAC counter may include a first quantity of (e.g., 16) counter bits to count row accesses at a row of the memory device 145 and a second quantity of (e.g., eight) bits for ECC (e.g., error correcting the 16 counter bits). Accordingly, the PRAC counter may support an ECC engine with single error correction (SEC), double error detection (DED). In some examples, the memory device 145 may use one or more GRCS columns within the GRCS plane 210 for redundancy (e.g., normal redundancy). The memory device 145 may also select CS columns for the PRAC counter based on a write time measurement (e.g., a tWR char) for the CS columns. For example, the memory device 145 may select the CS columns that have a write time that satisfies a threshold (e.g., CS columns that have a “best” write time among all other columns, or otherwise satisfy a performance metric associated with write time).

In a first alternative, the memory device 145 may split two CS columns used for the PRAC counter (e.g., the PRHT counter) between a set of GRCS columns (e.g., 16 GRCS columns and a set of column plane CS columns (e.g., a set of 65 CP7 CS columns). During a test time for the memory device 145, a testing device (or in some cases, the memory device 145) may select a GRCS column based on a writeback time of the GRCS column (e.g., based on the writeback time satisfying a threshold). Then, the memory device 145 may use a set of remaining GRCS columns (e.g., 15 other GRCS columns) for regular repair operations. The testing device may also select a CS column from a column plane (e.g., a CP7 CS column) based on a writeback time of the CS column satisfying a threshold. The CS column may be selected for a set of PRAC bits (e.g., eight bits of the PRAC counter). In some cases, the memory device 145 may remap a set of CS columns to GRCS column addresses, PRAC bit addresses, or both, to account for the CS column selection. Accordingly, the memory device 145 may mitigate (e.g., negate) an impact of relatively highly resistive access devices (e.g., at a tail end of a distribution) in the writeback time for the PRAC counter.

In some implementations, the memory device 145 (e.g., via the testing device) may refrain from testing one or more CS columns for writeback time directly. Instead, the memory device 145 may simply swap CS columns to achieve sufficient row hammer mitigation. In some examples, the PRAC counter may include 16 bits for storing a count value, ECC bits, redundancy bits, or any combination thereof. In some cases, the memory device 145 may use relatively fewer bits for ECC and redundancy (e.g., after selecting CS columns with a target writeback time). Accordingly, the memory device 145 may implement a row hammer tracking technique that adds relatively little die size and sufficiently mitigates problems associated with a 1 transistor, 1 capacitor array structure.

In a second alternative, the memory device 145 may use one or more CS columns from one or more column planes for the PRAC counter. For example, the memory device 145 may have one or more extra CS columns in one or more column planes. In one example, the memory device has an extra CS column in the column plane 205-a and an extra CS column in the column plane 205-b). The memory device 145 may map the a first CS column (e.g., one of the CS columns of the column plane including the extra CS column) of the column plane 205-a to a first subset of bits of the PRAC counter and may map a second CS column of the second column plane 205-b to a second subset of bits of the PRAC counter (e.g., to improve writeback time optimization). In some cases, the memory device 145 may perform the mapping in a similar manner as in the first alternative. In some examples, each column plane 205 may include a set of CS columns from which to select, where some column planes 205 include one or more extra CS columns. For example, while generally column planes 205 include 64 CS columns, each of one or more specified column planes may include 65 CS columns to choose from to use for the PRAC counter (e.g., the memory device 145 may use one CS column of the 65 options, and the memory device 145 may use the remaining 64 CS columns for regular memory storage and operations) to improve writeback time. Accordingly, the memory device 145 may further mitigate (e.g., negate) an impact of relatively highly resistive access devices (e.g., at a tail end of a distribution).

Similar to the first alternative, the memory device 145 (e.g., via the testing device) may refrain from testing one or more CS columns for writeback time directly in the second alternative. Instead, the memory device 145 may simply swap CS columns to achieve sufficient row hammer mitigation. For example, the memory device 145 may swap out CS columns for the PRAC counter until the PRAC counter achieves a performance level that is above a performance threshold (e.g., until the PRAC counter appears to not fail an ECC operation). In some implementations, the second alternative may allow the memory device 145 to perform row hammer tracking without using a GRCS column. The second alternative may result in a slightly larger and more conservative array structure for the memory device 145. In some cases, the memory device 145 may select the pair of CPs such that the pair of CPs are relatively close together (e.g., in two adjacent column planes 205, improving peripheral routing techniques).

In some implementations, the memory device 145 may perform a repair method on a per-bank basis. For example, the memory device 145 may perform the repair method to map a set of PRHT bits to a CS column. In some cases, the memory device 145 may use one or more columns of the GRCS plane 210 for the PRHT counter (e.g., the PRAC counter). For example, the memory device 145 may select a first CS column (CS column 0) of the GRCS plane 210 as a default column for the PRHT counter, but may change to one or more other GRCS columns of the GRCS plane for the PRHT counter to improve a writeback time for the PRHT counter. In some implementations, the memory device 145 may apply a similar repair method to select a CS column from a column plane 205 (e.g., using an extra CS column as a PRHT default column and then swapping with any remaining CS columns to improve the writeback time for the PRHT counter).

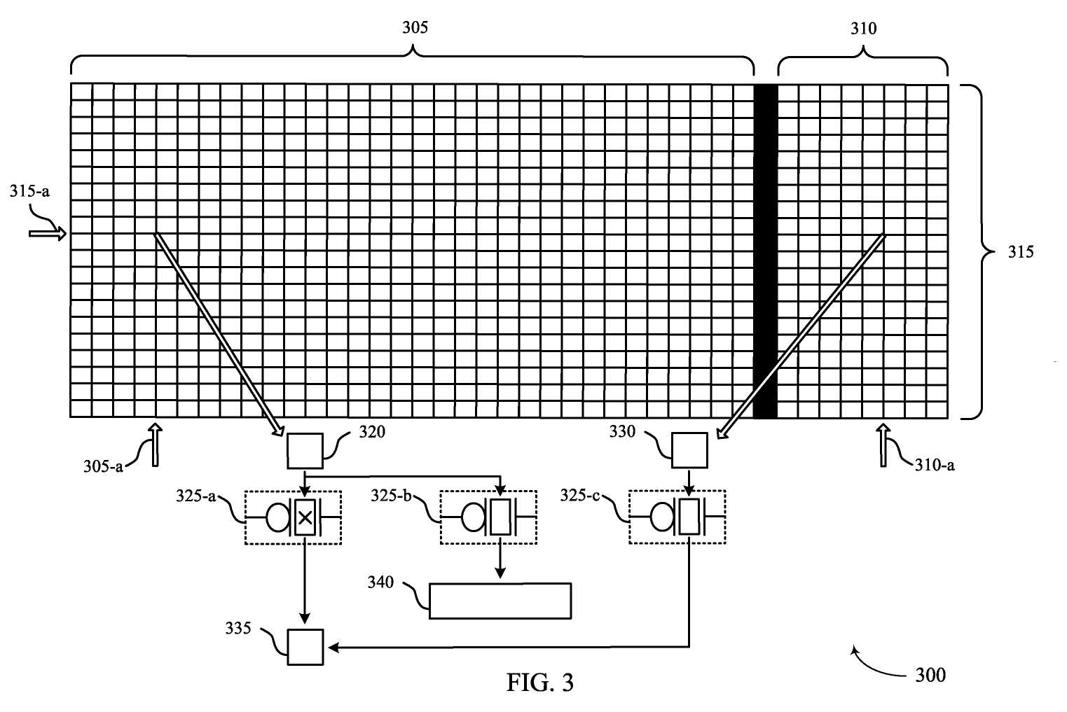

FIG. 3 shows an example of a memory array diagram 300 that supports per row hammer tracking array structure in accordance with examples as disclosed herein. The memory array diagram 300 may illustrate a memory array of a memory device 145 as described with reference to FIGS. 1 and 2. The memory array diagram 300 may include a set of memory cells including a first set of memory cells organized into a set of CS columns 305 (e.g., 32 normal CS columns) and a second set of memory cells organized into a set of GRCS columns 310. The set of memory cells may be further organized into a set of rows 315. The set of rows 315 may be referred to as a set of word lines. In some implementations, the memory device 145 may perform one or more access operations on the set of memory cells by activating a row 315 of the set of rows 315 and a column (e.g., a CS column 305 or a GRCS column 310).

In some implementations, each intersection of a row 315 (e.g., a word line) and a CS column 305 may provide (e.g., output) a first set of data bits 320 (e.g., eight bits of information). For example, if the memory device 145 activates a row 315-a and a CS column 305-a, the memory array may output a first set of data bits 320 to a set of data pins 335 (e.g., DQ). The set of data pins 335 may include one or more data pins. In some examples, a first fuse location 325-a may be coupled with (e.g., between) the memory array and the set of data pins 335. As described herein, a fuse location may refer to a set of one or more fuses of a fuse array, or in some cases, a set of one or more switches. In some cases, the memory device 145 (or another device) may program the first fuse location 325-a to a first state (e.g., refraining from blowing the fuse) or a first value (e.g., “open”) to allow the first set of data bits 320 to be output to the set of data pins 335. Additionally, or alternatively, the memory device 145 may program the first fuse location 325-a to a second state (e.g., blowing the fuse) or a second value (e.g., “closed”) such that the first set of data bits 320 is not output to the set of data pins 335.

At a time of testing the memory device 145 (e.g., when the part is at a probe), a testing device may test each row 315 (e.g., each word line) of the set of rows 315. For example, for a first row 315 (and for each row 315), the testing device may determine (e.g., find) which CS column 305 of the set of CS columns 305 on the first row 315 has a writeback time (e.g., tWR performance) that satisfies (e.g., is less than) a threshold writeback time (e.g., which CS column 305 has the best writeback time). In some cases, the testing device may determine which CS column 305 has a writeback time satisfying the threshold writeback time for each bit of a set of bits (e.g., 8 bits) corresponding to the first row 315 and the CS column 305 (e.g., the set of bits output after activating the first row 315 and the CS column 305). In the following example, the testing device may determine that the CS column 305-a has a writeback time satisfying the threshold writeback time (e.g., determining that CS = 4 has a writeback time that satisfies a threshold associated with a desired tWR, or that CS = 4 has a best tWR performance).

The testing device (or the memory device 145) may blow one or more fuses associated with the CS column 305-a (e.g., since CS = 4 has the best tWR performance), mapping the CS column 305-a to a GRCS column (e.g., a redundant CS column). In some cases, this process may be referred to as a “reverse repair” (e.g., repairing out a best CS column, instead of repairing out a failing CS column).

A second fuse location 325-b may be coupled with the memory array and a counter circuit 340 (e.g., a set of bits within a PRAC counter circuit or a PRHT counter circuit). In some implementations, the counter circuit 340 may store a set of bits for a counter (e.g., a PRAC counter or a PRHT counter). The second fuse location 325-b and the first fuse location 325-a may be a same fuse location (e.g., with one or more fuses for performing the mapping between the CS column 305-a and the counter circuit 340). In some implementations (e.g., in accordance with programming the first fuse location 325-a), the memory device 145 may program the second fuse location 325-b to the first state (e.g., refraining from blowing the fuse) or a first value (e.g., “open”) to allow the first set of data bits 320 to be output to the counter circuit 340. Additionally, or alternatively, the memory device 145 may program the second fuse location 325-b to a second state (e.g., blowing the fuse) or a second value (e.g., “closed”) such that the second set of data bits 330 is output to the set of data pins 335.

A third fuse location 325-c may be coupled with the memory array and with the set of data pins 335. For example, in accordance with programming the first fuse location 325-a, the memory device 145 may program the third fuse location 325-c to the first state (e.g., refraining from blowing the fuse) or a first value (e.g., “open”) to allow the second set of data bits 330 to be output to the set of data pins 335. Additionally, or alternatively, the memory device 145 may program the third fuse location 325-c to a second state (e.g., blowing the fuse) or a second value (e.g., “closed”) such that the second set of data bits 330 is not output to the set of data pins 335. In some cases, the first fuse location 325-a and the third fuse location 325-c may be a same fuse location (e.g., with one or more fuses for performing the mapping between the GRCS column 310-a and the set of data pins 335).

As illustrated in FIG. 3, the memory device 145 may program the first fuse location 325-a, the second fuse location 325-b, and the third fuse location 325-c such that the first set of data bits 320 is mapped to the counter circuit 340 and such that the second set of data bits 330 is output to the set of data pins 335. In some implementations, the memory device 145 may receive an access command that indicates a read operation at an address corresponding to the CS column 305-a. In response, the memory device 145 may activate (e.g., fire) a GRCS column 310 programmed (e.g., mapped) to the CS column 305-a. That is, the memory device 145 may activate the row 315-a and the GRCS column 310-a such that the memory array outputs a second set of data bits 330 (e.g., a set of redundant bits from GRCS area). Then, the memory device 145 may activate the CS column 305-a to access the counter circuit 340 and to increment a count value stored at the counter circuit 340 (e.g., in response to a deactivation of the row 315-a).

In some implementations, the testing device (or the memory device 145) may group the set of rows 315 (e.g., word lines) into one or more regions prior to a testing operation to select a CS column for the counter circuit 340 (e.g., as described with reference to FIG. 2. Then, the testing device may select the CS column for the counter circuit 340 via a respective testing operation for each region. For example, the testing device may perform a respective testing operation for each bank of a set of banks (e.g., on a per-bank basis), or for each region of a set of regions of each bank (e.g., a testing operation for each of a set of quantities of rows of each bank). In some examples, the memory device 145 may use one or more GRCS columns 310 of the set of GRCS columns 310 for repairing out CS columns 305 that have relatively poor performance (e.g., relatively high writeback times).

In some cases, a device (e.g., the testing device, the memory device 145, or both) may select one or more CS columns 305 (e.g., three CS columns 305) for the counter circuit 340 (e.g., which may include 24 bits) using the techniques described herein. Thus, the device may program a set of fuse locations to map a subset of CS columns 305 to the counter circuit 340, and to map a subset of GRCS columns 310 to the subset of CS columns 305. Accordingly, the memory device 145 may receive one or more read commands for at least one of the subset of CS columns 305. In response, the memory device 145 may perform a read operation on a respective GRCS column 310 mapped to the at least one of the subset of CS columns 305.

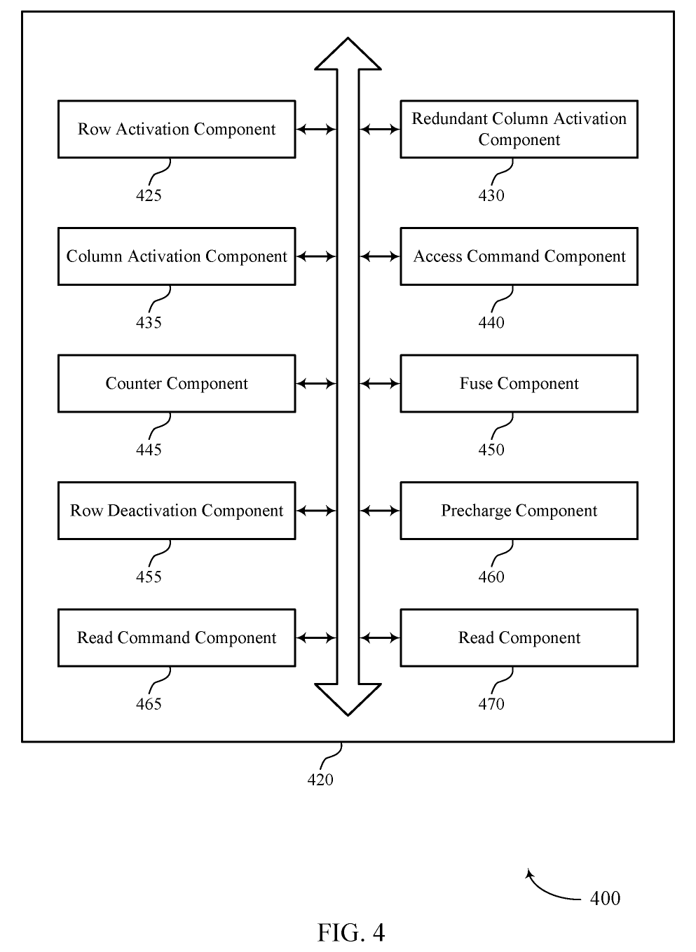

FIG. 4 shows a block diagram 400 of a memory system 420 that supports per row hammer tracking array structure in accordance with examples as disclosed herein. The memory system 420 may be an example of aspects of a memory system as described with reference to FIGS. 1 through 3. The memory system 420, or various components thereof, may be an example of means for performing various aspects of per row hammer tracking array structure as described herein. For example, the memory system 420 may include a row activation component 425, a redundant column activation component 430, a column activation component 435, an access command component 440, a counter component 445, a fuse component 450, a row deactivation component 455, a precharge component 460, a read command component 465, a read component 470, or any combination thereof. Each of these components, or components of subcomponents thereof (e.g., one or more processors, one or more memories), may communicate, directly or indirectly, with one another (e.g., via one or more buses).

The row activation component 425 may be configured as or otherwise support a means for activating a first row of a memory array, the first row corresponding to a first row address. The redundant column activation component 430 may be configured as or otherwise support a means for activating a redundant column to perform a first access operation on a set of data bits associated with a first column address corresponding to a first column of the memory array. The column activation component 435 may be configured as or otherwise support a means for activating the first column of the memory array to perform a second access operation on a set of counter bits of a counter circuit that includes a count value corresponding to a quantity of accesses at the first row.

In some examples, the access command component 440 may be configured as or otherwise support a means for receiving an access command for the first access operation, the access command indicating the first row address and the first column address, where activations of the first row, the redundant column, and the first column are based at least in part on the access command.

In some examples, the counter component 445 may be configured as or otherwise support a means for adjusting the count value in response to activation of the first row. In some examples, the counter component 445 may be configured as or otherwise support a means for writing, in response to an indication to deactivate the first row, a subset of bits of the count value to a set of memory cells associated with the first row address and the first column address.

In some examples, the fuse component 450 may be configured as or otherwise support a means for writing a value at a fuse location associated with the redundant column, where the first column address is mapped to the redundant column based at least in part on writing the value at the fuse location, and where activation of the redundant column is based at least in part on the value at the fuse location.

In some examples, the fuse component 450 may be configured as or otherwise support a means for writing a value at a fuse location associated with the redundant column, where the set of counter bits is mapped to the first column based at least in part on writing the value at the fuse location, and where activation of the first column is based at least in part on the value at the fuse location.

In some examples, the row deactivation component 455 may be configured as or otherwise support a means for receiving an indication to deactivate the first row. In some examples, the precharge component 460 may be configured as or otherwise support a means for performing a precharge operation on the first row in response to the indication to deactivate the first row and based at least in part on activation of the first column.

In some examples, the read command component 465 may be configured as or otherwise support a means for receiving a read command associated with the first column address. In some examples, the read component 470 may be configured as or otherwise support a means for performing, in response to the read command, a read operation at the redundant column in accordance with a mapping between the first column address and the redundant column.

In some examples, the row activation component 425 may be configured as or otherwise support a means for activating a second row of the memory array, the second row corresponding to a second row address. In some examples, the redundant column activation component 430 may be configured as or otherwise support a means for activating a second redundant column to perform a third access operation on a set of data bits associated with a second column address corresponding to a second column of the memory array. In some examples, the column activation component 435 may be configured as or otherwise support a means for activating the second column of the memory array to perform a fourth access operation on a second set of counter bits of the counter circuit.

In some examples, the redundant column includes a global redundant column select column of a set of global redundant column select columns.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

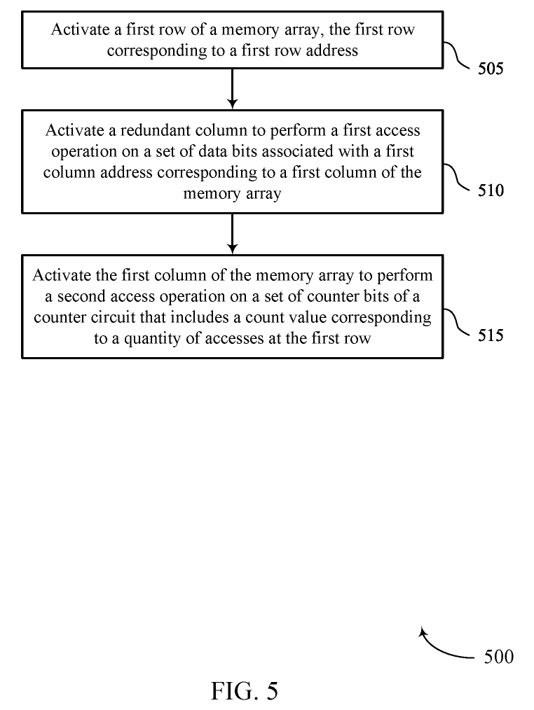

FIG. 5 shows a flowchart illustrating a method 500 that supports per row hammer tracking array structure in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include activating a first row of a memory array, the first row corresponding to a first row address. In some examples, aspects of the operations of 505 may be performed by a row activation component 425 as described with reference to FIG. 4.

At 510, the method may include activating a redundant column to perform a first access operation on a set of data bits associated with a first column address corresponding to a first column of the memory array. In some examples, aspects of the operations of 510 may be performed by a redundant column activation component 430 as described with reference to FIG. 4.

At 515, the method may include activating the first column of the memory array to perform a second access operation on a set of counter bits of a counter circuit that includes a count value corresponding to a quantity of accesses at the first row. In some examples, aspects of the operations of 515 may be performed by a column activation component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for activating a first row of a memory array, the first row corresponding to a first row address; activating a redundant column to perform a first access operation on a set of data bits associated with a first column address corresponding to a first column of the memory array; and activating the first column of the memory array to perform a second access operation on a set of counter bits of a counter circuit that includes a count value corresponding to a quantity of accesses at the first row.

Aspect 2: The method, apparatus, or non-transitory computer-readable medium of aspect 1, further including operations, features, circuitry, logic, means, or instructions, or any combination thereof for receiving an access command for the first access operation, the access command indicating the first row address and the first column address, where activations of the first row, the redundant column, and the first column are based at least in part on the access command.

Aspect 3: The method, apparatus, or non-transitory computer-readable medium of any of aspects 1 through 2, further including operations, features, circuitry, logic, means, or instructions, or any combination thereof for adjusting the count value in response to activation of the first row and writing, in response to an indication to deactivate the first row, a subset of bits of the count value to a set of memory cells associated with the first row address and the first column address.

Aspect 4: The method, apparatus, or non-transitory computer-readable medium of any of aspects 1 through 3, further including operations, features, circuitry, logic, means, or instructions, or any combination thereof for writing a value at a fuse location associated with the redundant column, where the first column address is mapped to the redundant column based at least in part on writing the value at the fuse location, and where activation of the redundant column is based at least in part on the value at the fuse location.

Aspect 5: The method, apparatus, or non-transitory computer-readable medium of any of aspects 1 through 4, further including operations, features, circuitry, logic, means, or instructions, or any combination thereof for writing a value at a fuse location associated with the redundant column, where the set of counter bits is mapped to the first column based at least in part on writing the value at the fuse location, and where activation of the first column is based at least in part on the value at the fuse location.

Aspect 6: The method, apparatus, or non-transitory computer-readable medium of any of aspects 1 through 5, further including operations, features, circuitry, logic, means, or instructions, or any combination thereof for receiving an indication to deactivate the first row and performing a precharge operation on the first row in response to the indication to deactivate the first row and based at least in part on activation of the first column.

Aspect 7: The method, apparatus, or non-transitory computer-readable medium of any of aspects 1 through 6, further including operations, features, circuitry, logic, means, or instructions, or any combination thereof for receiving a read command associated with the first column address and performing, in response to the read command, a read operation at the redundant column in accordance with a mapping between the first column address and the redundant column.

Aspect 8: The method, apparatus, or non-transitory computer-readable medium of any of aspects 1 through 7, further including operations, features, circuitry, logic, means, or instructions, or any combination thereof for activating a second row of the memory array, the second row corresponding to a second row address; activating a second redundant column to perform a third access operation on a set of data bits associated with a second column address corresponding to a second column of the memory array; and activating the second column of the memory array to perform a fourth access operation on a second set of counter bits of the counter circuit.

Aspect 9: The method, apparatus, or non-transitory computer-readable medium of any of aspects 1 through 8, where the redundant column includes a global redundant column select column of a set of global redundant column select columns.

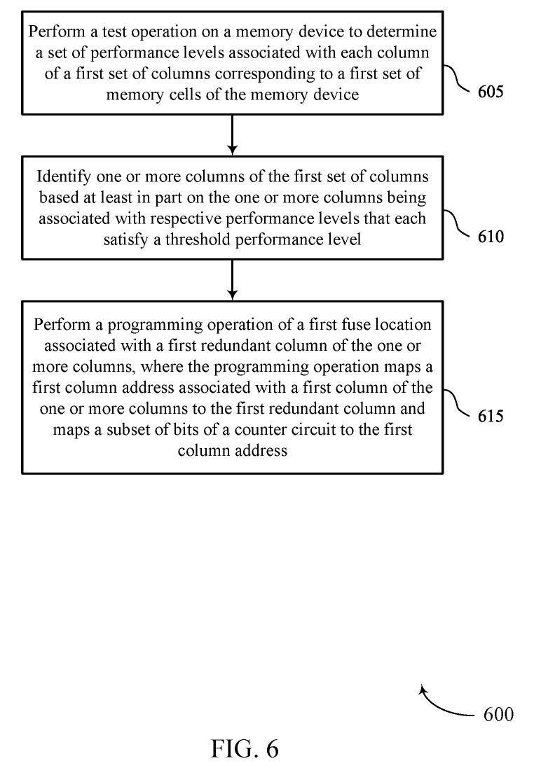

FIG. 6 shows a flowchart illustrating a method 600 that supports per row hammer tracking array structure in accordance with examples as disclosed herein. The operations of method 600 may be implemented by a testing system or its components as described herein. For example, the operations of method 600 may be performed by a testing system as described with reference to FIGS. 1 through 3. In some examples, a testing system may execute a set of instructions to control the functional elements of the device to perform the described functions. Additionally, or alternatively, the testing system may perform aspects of the described functions using special-purpose hardware.

At 605, the method may include performing a test operation on a memory device to determine a set of performance levels associated with each column of a first set of columns corresponding to a first set of memory cells of the memory device.

At 610, the method may include identifying one or more columns of the first set of columns based at least in part on the one or more columns being associated with respective performance levels that each satisfy a threshold performance level.

At 615, the method may include performing a programming operation of a first fuse location associated with a first redundant column of the one or more columns, where the programming operation maps a first column address associated with a first column of the one or more columns to the first redundant column and maps a subset of bits of a counter circuit to the first column address.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for performing a test operation on a memory device to determine a set of performance levels associated with each column of a first set of columns corresponding to a first set of memory cells of the memory device; identifying one or more columns of the first set of columns based at least in part on the one or more columns being associated with respective performance levels that each satisfy a threshold performance level; and performing a programming operation of a first fuse location associated with a first redundant column of the one or more columns, where the programming operation maps a first column address associated with a first column of the one or more columns to the first redundant column and maps a subset of bits of a counter circuit to the first column address.

Aspect 11: The method, apparatus, or non-transitory computer-readable medium of aspect 10, where performing the test operation includes operations, features, circuitry, logic, means, or instructions, or any combination thereof for subdividing the first set of memory cells into a plurality of subregions including at least a first subregion of word lines and a second subregion of word lines; determining a first set of performance levels associated with each column of the first set of columns at the first subregion of word lines; and determining a second set of performance levels associated with each column of the first set of columns at the second subregion of word lines, where identifying the one or more columns is based at least in part on the first set of performance levels, the second set of performance levels, or both.

Aspect 12: The method, apparatus, or non-transitory computer-readable medium of any of aspects 10 through 11, further including operations, features, circuitry, logic, means, or instructions, or any combination thereof for performing a second programming operation of a second fuse location associated with a second redundant column such that a second column address associated with a second column of the one or more columns maps to the second redundant column and such that a second subset of bits of the counter circuit maps to the second column address.

Aspect 13: The method, apparatus, or non-transitory computer-readable medium of aspect 12, further including operations, features, circuitry, logic, means, or instructions, or any combination thereof for performing a third programming operation of a third fuse location associated with a third redundant column such that a third column address associated with a third column of the one or more columns maps to the third redundant column and such that a third subset of bits of the counter circuit maps to the third column address.

Aspect 14: The method, apparatus, or non-transitory computer-readable medium of any of aspects 10 through 13, where the first redundant column includes a global redundant column select column of a set of global redundant column select columns.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 15: A memory system, including: a first set of memory cells including a first set of columns; a second set of memory cells including a second set of columns; a plurality of word lines configured to access respective rows of the first set of memory cells and the second set of memory cells; a fuse array including a first fuse location, where the first fuse location is associated with a second column of the second set of columns; a first set of switches coupled with the first fuse location and configured to map a first column address associated with a first column of the first set of columns to the second column of the second set of columns based at least in part on a programmed value at the first fuse location; and a second set of switches configured to map a subset of bits of a counter to the first column address.

Aspect 16: The memory system of aspect 15, further including: counter circuitry configured to: obtain a portion of a counter value from the first column via the first set of switches upon activation of a word line of the plurality of word lines; and increment the counter value in response to activation of the word line.

Aspect 17: The memory system of any of aspects 15 through 16, further including: processing circuitry configured to write the programmed value at the first fuse location.

Aspect 18: The memory system of any of aspects 15 through 17, where the second set of switches are coupled with a second fuse location of the fuse array.

Aspect 19: The memory system of any of aspects 15 through 18, where the first fuse location includes a subset of one or more fuses within the fuse array.

Aspect 20: The memory system of any of aspects 15 through 19, where the first set of columns includes columns addressed via column select bits of an access command, and the second set of columns includes a set of global redundant column select columns.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory device, comprising:
a memory array comprising a plurality of memory cells; and
processing circuitry coupled with the memory array and configured to cause the memory device to:
activate a first row of the memory array, the first row corresponding to a first row address;
activate a redundant column to perform a first access operation on a set of data bits associated with a first column address corresponding to a first column of the memory array; and
activate the first column of the memory array to perform a second access operation on a set of counter bits of a counter circuit that includes a count value corresponding to a quantity of accesses at the first row.

2. The memory device of claim 1, wherein the processing circuitry is further configured to cause the memory device to:
receive an access command for the first access operation, the access command indicating the first row address and the first column address, wherein activations of the first row, the redundant column, and the first column are based at least in part on the access command.

3. The memory device of claim 1, wherein the processing circuitry is further configured to cause the memory device to:
adjust the count value in response to activation of the first row; and
write, in response to an indication to deactivate the first row, a subset of bits of the count value to a set of memory cells associated with the first row address and the first column address.

4. The memory device of claim 1, wherein the processing circuitry is further configured to cause the memory device to:
write a value at a fuse location associated with the redundant column, wherein the first column address is mapped to the redundant column based at least in part on writing the value at the fuse location, and wherein activation of the redundant column is based at least in part on the value at the fuse location.

5. The memory device of claim 1, wherein the processing circuitry is further configured to cause the memory device to:
write a value at a fuse location associated with the redundant column, wherein the set of counter bits is mapped to the first column based at least in part on writing the value at the fuse location, and wherein activation of the first column is based at least in part on the value at the fuse location.

6. The memory device of claim 1, wherein the processing circuitry is further configured to cause the memory device to:
receive an indication to deactivate the first row; and
perform a precharge operation on the first row in response to the indication to deactivate the first row and based at least in part on activation of the first column.

7. The memory device of claim 1, wherein the processing circuitry is further configured to cause the memory device to:
receive a read command associated with the first column address; and
perform, in response to the read command, a read operation at the redundant column in accordance with a mapping between the first column address and the redundant column.

8. The memory device of claim 1, wherein the processing circuitry is further configured to cause the memory device to:
activate a second row of the memory array, the second row corresponding to a second row address;
activate a second redundant column to perform a third access operation on a set of data bits associated with a second column address corresponding to a second column of the memory array; and
activate the second column of the memory array to perform a fourth access operation on a second set of counter bits of the counter circuit.

9. The memory device of claim 1, wherein the redundant column comprises a global redundant column select column of a set of global redundant column select columns.

10. A method, comprising:
performing a test operation on a memory device to determine a set of performance levels associated with each column of a first set of columns corresponding to a first set of memory cells of the memory device;
identifying one or more columns of the first set of columns based at least in part on the one or more columns being associated with respective performance levels that each satisfy a threshold performance level; and
performing a programming operation of a first fuse location associated with a first redundant column of the one or more columns, wherein the programming operation maps a first column address associated with a first column of the one or more columns to the first redundant column and maps a subset of bits of a counter circuit to the first column address.

11. The method of claim 10, wherein performing the test operation comprises:
subdividing the first set of memory cells into a plurality of subregions including at least a first subregion of word lines and a second subregion of word lines;
determining a first set of performance levels associated with each column of the first set of columns at the first subregion of word lines; and
determining a second set of performance levels associated with each column of the first set of columns at the second subregion of word lines, wherein identifying the one or more columns is based at least in part on the first set of performance levels, the second set of performance levels, or both.

12. The method of claim 10, further comprising:
performing a second programming operation of a second fuse location associated with a second redundant column such that a second column address associated with a second column of the one or more columns maps to the second redundant column and such that a second subset of bits of the counter circuit maps to the second column address.

13. The method of claim 12, further comprising:
performing a third programming operation of a third fuse location associated with a third redundant column such that a third column address associated with a third column of the one or more columns maps to the third redundant column and such that a third subset of bits of the counter circuit maps to the third column address.

14. The method of claim 10, wherein the first redundant column comprises a global redundant column select column of a set of global redundant column select columns.

15. A memory system, comprising:
a first set of memory cells comprising a first set of columns;
a second set of memory cells comprising a second set of columns;
a plurality of word lines configured to access respective rows of the first set of memory cells and the second set of memory cells;
a fuse array comprising a first fuse location, wherein the first fuse location is associated with a second column of the second set of columns;
a first set of switches coupled with the first fuse location and configured to map a first column address associated with a first column of the first set of columns to the second column of the second set of columns based at least in part on a programmed value at the first fuse location; and
a second set of switches configured to map a subset of bits of a counter to the first column address.

16. The memory system of claim 15, further comprising:
counter circuitry configured to:
obtain a portion of a counter value from the first column via the first set of switches upon activation of a word line of the plurality of word lines; and
increment the counter value in response to activation of the word line.

17. The memory system of claim 15, further comprising:
processing circuitry configured to write the programmed value at the first fuse location.

18. The memory system of claim 15, wherein the second set of switches are coupled with a second fuse location of the fuse array.

19. The memory system of claim 15, wherein the first fuse location comprises a subset of one or more fuses within the fuse array.

20. The memory system of claim 15, wherein:
the first set of columns comprises columns addressed via column select bits of an access command, and
the second set of columns comprises a set of global redundant column select columns.
